(19) United States
(12) Patent Application Publication
(10) Pub. No.: US 2010/0145623 A1
(43) Pub. Date: Jun. 10, 2010

(54) Methods and systems for using ultraviolet index data in plant evaluation applications

(76) Inventors: Matthew W. Eckerle, Oakland, CA (US); David L. Wilkins, Oakland, CA (US)

Correspondence Address: Scot A. Reader, Esq.;Suite 228, 1320 Pearl Street, Boulder, CO, 80302, US

(21) Appl. No.: 12/316,208

(22) Filed: Dec. 10, 2008

(51) Int. Cl. G06F 19/00; A01G 7/00

(52) U.S. Cl. 702/19; 47/58.1 R

(57) ABSTRACT

Methods and systems for using UVI data in plant evaluation applications avail themselves of the correlation between PAR and UVI to estimate PAR based on UVI and apply the PAR estimate in a plant evaluation application, such as a plant selection or plant heath diagnostics application. A UVI-based PAR estimate may be used, for example, to dramatically reduce the time that an environmental probe must be deployed at a plant site by normalizing a sensor-based PAR estimate generated from short-term measurements taken by the environmental probe to produce a faster, more accurate and more reliable plant evaluation.

### BACKGROUND OF THE INVENTION

The present invention relates to using ultraviolet index (UVI) data in visible spectrum applications, such as plant evaluation applications.

UVI is a World Health Organization and World Meteorological Organization standardized measure of the atmospheric transmission of ultraviolet radiation from the Sun at a given place and time. UVI is proportional to the atmospheric transmission of ultraviolet radiation within the spectral wavelength range of 290 and 400 nanometers, and normally ranges between zero (minimum) and 15 (maximum). In the United States, daily regional UVI are forecast by the National Weather Service to provide the American public an easy way to evaluate the risk of skin exposure to the Sun in their region. Additionally, regional UVI are published by weather services more frequently. These regional UVI are either predictions made by computer models of the atmospheric transmission of ultraviolet radiation and account for the effects of altitude, atmospheric ozone concentration and weather (e.g. clouds), all of which which can impact atmospheric transmission of ultraviolet radiation, or real values calculated from measured ultraviolet light at a nearby weather station.

Photosynthetically active radiation (PAR) is a measure of the atmospheric transmission of visible radiation from the Sun at a given place and time within the spectral wavelength range of 400 to 700 nanometers, and is normally calculated in micromoles per second per meter squared or moles per day per meter squared. This is the spectral range that is absorbed by plants in photosynthesis. PAR indicates the solar energy available to plants, and as such is very useful in modeling agricultural, ecological and horticultural systems, including plant evaluation systems.

PAR data are not as widely available or frequently updated as UVI data. For example, the website AccuWeather.com publishes hourly UVI data for various locales in the United States, whereas there is no comparable publication of PAR data. However, PAR and UVI tend to be highly correlated since atmospheric transmission of ultraviolet radiation and visible radiation is affected similarly by atmospheric conditions, and PAR and UVI are calculated similarly.

### SUMMARY OF THE INVENTION

The present invention, in a basic feature, uses UVI data in plant evaluation applications. The present invention avails itself of the correlation between PAR and UVI to estimate PAR based on UVI and applies the PAR estimate in a plant evaluation application, such as a plant selection or plant heath diagnostics application. A UVI-based PAR estimate may be used, for example, to dramatically reduce the time that an environmental probe must be deployed at a plant site by normalizing a sensor-based PAR estimate generated from short-term measurements taken by the environmental probe to generate a faster, more accurate and more reliable plant evaluation.

In one aspect of the invention, therefore, a computer comprises a processor and a first communications interface communicatively coupled with the processor, wherein the computer receives via the first communications interface UVI data and under control of the processor determines UVI-based PAR data as a function of the UVI data and applies the UVI-based PAR data in a plant evaluation application. The computer may also comprise a second communications interface communicatively coupled with the processor, wherein the computer receives via the second communications interface sensor-based PAR data and under control of the processor applies the sensor-based PAR data in conjunction with the UVI-based PAR data in the plant evaluation application. The computer may under control of the processor normalize the sensor-based PAR data using the UVI-based PAR data. The UVI-based PAR data may comprise a first PAR estimate applicable to a sensing period and a second PAR estimate applicable to an extended period, and the computer under control of the processor may normalize the sensor-based PAR data using the first and second PAR estimates. The first PAR estimate may be determined using UVI data applicable to the sensing period and may be further determined using solar zenith angle data applicable to the sensing period. The second PAR estimate may be determined using UVI data applicable to the extended period and may be further determined using solar zenith angle data applicable to the extended period, or may be determined using historical PAR data applicable to the extended period. The computer may receive location information and under control of the processor transmit via the first communications interface a UVI query comprising the location information in response to which the computer receives via the first communications interface the UVI data. The computer may receive the location information from a probe controller via the second communications interface. The computer may comprise a user input device communicatively coupled with the processor and the computer may receive the location information via the user input device.

In another aspect of the invention, a plant evaluation method comprises the steps of transmitting location information, receiving UVI data in response to the location information, determining UVI-based PAR data based at least in part on the UVI data and applying the UVI-based PAR data in a plant evaluation application.

These and other aspects of the invention will be better understood by reference to the following detailed description taken in conjunction with the drawings that are briefly described below.

### BRIEF DESCRIPTION OF THE DRAWINGS

FIG. 1 shows a communication system in some embodiments of the invention.

FIG. 2 shows the probe controller of FIG. 1 in more detail.

FIG. 3 shows the computer of FIG. 1 in more detail.

FIG. 4 is a plot showing a relationship between PAR and UVI.

FIG. 5 is a flow diagram showing a method for using UVI-based PAR data in a plant evaluation application in some embodiments of the invention.

FIG. 6 is a flow diagram showing a method for using UVI-based PAR data in a plant evaluation application in other embodiments of the invention.

### DETAILED DESCRIPTION OF A PREFERRED EMBODIMENT

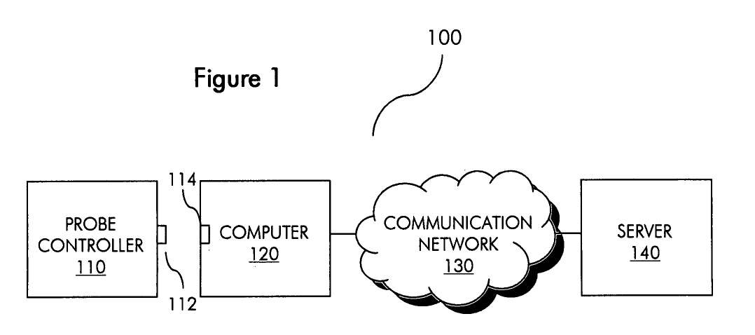

FIG. 1 shows a communication system 100 in some embodiments of the invention. Communication system 100 includes a computer 120 communicatively coupled with a server 140 via a communication network 130 and communicatively coupled with a probe controller 110. Within communication system 100, probe controller 110, computer 120 and server 140 interact to facilitate one or more plant evaluation applications, such as a plant selection and/or plant health diagnostics application. In some embodiments, communication system 100 supports both a plant selection and a plant health diagnostics application, and a user of computer 120 selects a desired plant evaluation application from among the multiple of supported plant evaluation applications.

In an exemplary plant selection application, computer 120 analyzes environmental data collected by probe controller 110 while installed at a proposed plant site and outputs a plant recommendation to a user. The plant recommendation recommends a plant species for installation at the proposed plant site and is output after the environmental data are cross-referenced for environmental compatibility against profiles of plant species in a regional plant database, which may be accessed locally on computer 120 or remotely via communication network 130. The plant recommendation may be further determined based on answers input by the user on computer 120 in response to interview questions, such as preferred color, size, price range, care level, etc. Computer 120 may further direct the user via communication network 130 to an advertising portal for identification of local retailers from which the recommended plant species may be purchased as well as pricing information.

In an exemplary plant health diagnostics application, computer 120 analyzes environmental data collected by probe controller 110 while installed at a plant site and outputs a plant health diagnosis to a user. The plant health diagnosis is output after the environmental data are compared with a species profile for a plant installed at the plant site. The plant health diagnosis identifies incompatibilities between the environment and the installed plant. The species profile is retrieved from a regional plant database, which may be accessed locally or remotely, based on a species identification of the installed plant from information input by the user. The user may identify the plant species directly or the plant species may be identified from answers responsive to interview questions. Computer 120 may further direct the user to a user forum and/or an advertising portal for resolving health problems with the installed plant. The advertising portal may provide local plant care information, including identification of local retailers, landscape architects, landscapers and purchasing information for plant care products and tools.

In both exemplary plant evaluation applications, environmental data collected by probe controller 110 and applied on computer 120 include PAR data calculated by probe controller 110 using light readings taken by a light sensor at the plant site. These sensor-based PAR data may estimate PAR at the plant site over the entire wavelength range of 400 to 700 nanometers or part of this wavelength range. The sensor-based PAR data are normalized and the normalized PAR data are compared on computer 120 with one or more plant species profiles to determine compatibility of PAR at the plant site with one or more plant species and output a plant evaluation. Normalization is performed because sensor-based PAR data may be taken over an abbreviated sensing period where abnormal weather patterns are experienced. Therefore, prior to comparison with the plant species profiles, the sensor-based PAR data are normalized using UVI-based PAR data determined using UVI data obtained from server 140.

Probe controller 110 interfaces with an environmental probe at an actual or prospective plant site to collect environmental data, and interacts with computer 120 to facilitate one or more plant evaluation applications using collected environmental data. In the illustrated embodiment, probe controller 110 is a portable controller that is removably couplable with a soil mount installed at a plant site to form an environmental probe that takes readings of environmental parameters at the plant site and has a USB connector 112 that is removably couplable with a USB port 114 on computer 120 for uploading environmental data for use in one or more plant evaluation applications. In other embodiments, a probe controller may be wirelessly connectable to a computer.

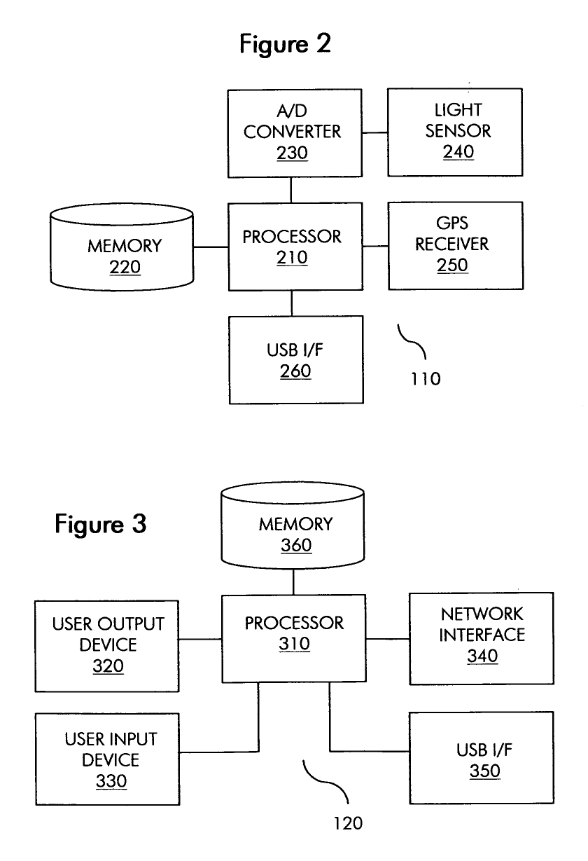

Turning momentarily to FIG. 2, probe controller 110 is shown to have a processor 210 communicatively coupled between a memory 220, an analog-to-digital (A/D) converter 230 that is coupled to a light sensor 240, a Global Positioning System (GPS) receiver 250 and a USB interface 260 that is coupled to USB connector 112. Naturally, probe controller 110 may have other environmental sensors, such as a humidity, soil moisture, soil pH and temperature sensors. Processor 210 performs computing functions including data manipulation and transmission and may be an application specific integrated circuit or microcontroller, for example. Memory 220 includes a random access memory (RAM) and a read-only memory (ROM).

When a user turns probe controller 110 “on” and probe controller 110 is connected to a soil mount at a plant site, light sensor 240 begins taking light readings that are digitized in A/D converters 230 en route to processor 210. Processor 210 processes the digitized light readings and stores them in memory 220 for later uploading to computer 120 via USB interface 260 and application on computer 120. Processing may include one or more of mathematical correction of the light readings, calculating sensor-based PAR data from the light readings by assuming a solar spectrum and time-stamping the sensor-based PAR data. Mathematical correction may include, for example, cosine correction performed to correct readings that are artificially low as a result of having been taken when the Sun is low in its zenith. In some embodiments, elements of the above-described processing may be performed by one or more other processing elements in communication system 100.

When a user turns probe controller 110 “on” and USB connector 112 is connected to USB port 114, processor 210 assists uploading of data to computer 120 for analysis on computer 120. Uploaded data include time-stamped, sensor-based PAR data. Uploaded data may also include location information (e.g. latitude, longitude, altitude) acquired by GPS receiver 250. GPS receiver 250 acquires location and time information from satellites. Processor 210 uses time information received from GPS receiver 250 to time-stamp data and uploads location information received from GPS receiver 250 via USB interface 260 for application on computer 120. In other embodiments, a probe controller may not have a GPS receiver. In these embodiments, a processor on the probe controller may time-stamp data using time information from a terrestrial clock source and the computer may obtain location information from a user of the computer, such as a zip code or a geoposition.

Computer 120 interacts with server 140 to facilitate one or more plant evaluation applications using time-stamped, sensor-based PAR data and location information uploaded from probe controller 110. Computer 120 may be a general purpose appliance, such as a personal computer, workstation, server, personal data assistant (PDA) or cellular phone, executing locally or remotely hosted plant evaluation software, or an custom appliance that is specially adapted for facilitating plant evaluation. FIG. 3 shows computer 120 in more detail. Computer 120 includes a user output device 320, a user input device 330, a network interface 340, a USB interface 350 and a memory 360, all of which are communicatively coupled with a processor 310. User output device 320 includes a mechanism for providing output to a user, such as a liquid crystal display panel, a light emitting diode panel or a cathode ray tube and/or speakers. User input device 330 includes a mechanism for accepting input from a user, such as one or more of a keyboard, keypad, touch screen and/or a microphone. Network interface 340 is a wired or wireless communications interface, such as a wired Ethernet, cellular, wireless metropolitan area network (WiMax) or wireless local area network (Wi-Fi) interface, that communicatively couples computer 120 with communication network 130. USB interface 350 is coupled to USB port 114 which is adapted to receive USB connector 112 of probe controller 110. Memory 360 includes one or more RAM and one or more ROM. Processor 310 executes software installed in memory 360 and interfaces with elements 320, 330, 340, 350, 360 to facilitate one or more plant evaluation applications, such as a plant selection and/or plant health diagnostics application.

Communication network 130 includes one or more wired or wireless data communication networks that have an arbitrary number of multiplexing nodes, such as Ethernet switches, WiMAX and/or Wi-Fi access points, Internet Protocol (IP) routers and/or cellular communication nodes, that execute data communication protocols to store and forward data traffic between computer 120 and server 140.

Server 140 is a query server that hosts regional UVI data retrievable using UVI queries having location information, such as a geoposition or zip code, and time information. Regional UVI data may include UVI determined by computer models or based on actual measurements for daily, monthly, yearly and/or other time horizons. In some embodiments, the regional UVI data is accessed via a governmental or commercial website hosted on server 140, such as AccuWeather.com. In some embodiments, server 140 also hosts solar zenith angle data retrievable using zenith angle queries having location information, such as a geoposition or zip code, and time information. Solar zenith angle data indicates the angle of the Sun with respect to normal at a given location and time.

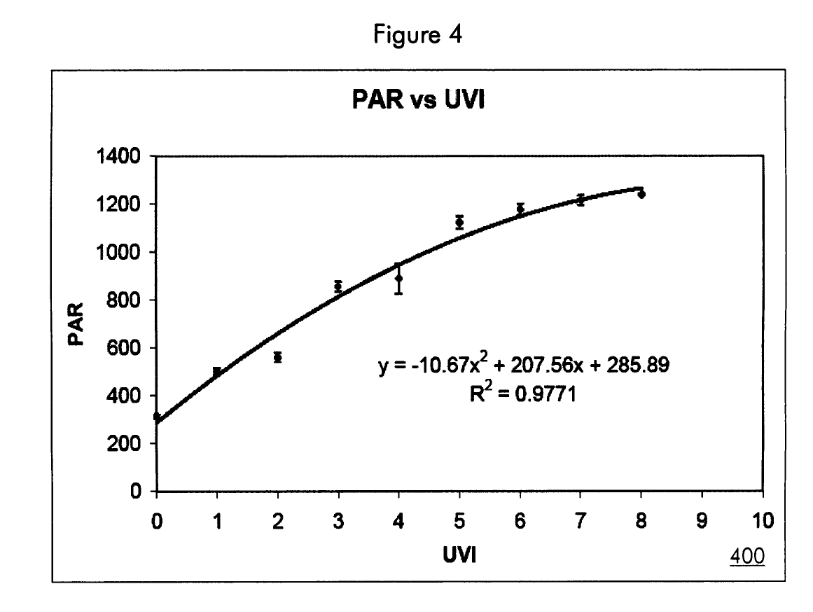

FIG. 4 is a plot 400 showing a mathematical relationship between PAR and UVI used by processor 310 to determine UVI-based PAR data from UVI data in some embodiments. In plot 400, UVI is shown on the x-axis and PAR (in micromoles per second per meter squared) is shown on the y-axis. A second degree polynomial regression curve having an R-squared correlation of 0.9771 drawn through data points shows that PAR increases with UVI from roughly 300 micromoles per second per meter squared at UVI=0 to above 1200 micromoles per second per meter squared at UVI=8. The formula for the regression curve is shown on plot 400.

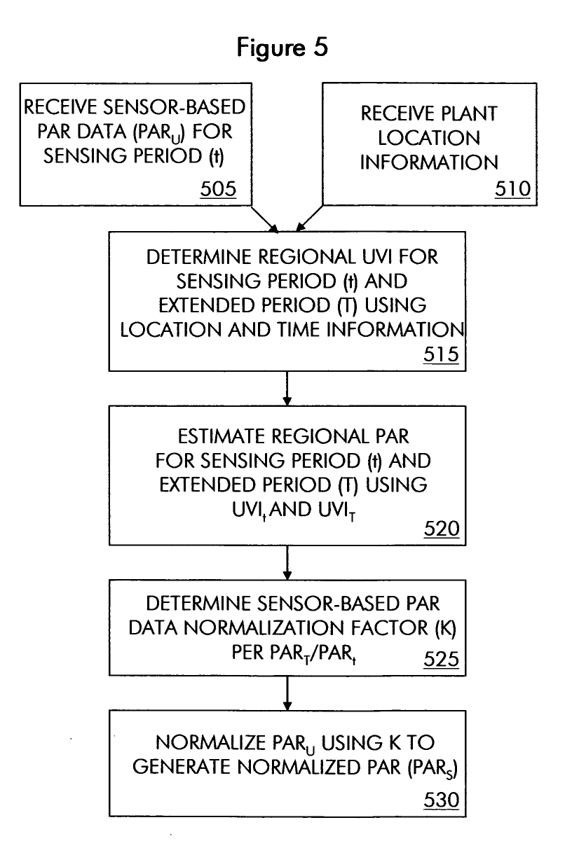

FIG. 5 shows a method for using UVI-based PAR data in a plant evaluation application in some embodiments of the invention. Before the method is performed, a user boots-up computer 120, launches software on processor 310 and inputs on user input device 330 a desired plant evaluation application, for example, plant selection or plant health diagnostics. Then, under control of processor 310, computer 120 normalizes sensor-based PAR data received from probe controller 110 using UVI-based PAR data to obtain a more accurate reading of PAR at the plant site. More specifically, turning to FIG. 5, processor 310 receives non-normalized, sensor-based PAR data PAR_{U} calculated by probe controller 110 based on light readings taken by light sensor 240 at the plant site over a sensing period t (505). The non-normalized, sensor-based PAR data PAR_{U} may be represented as average PAR during the sensing period t or may be a profile that describes PAR at various times during the sensing period t. Processor 310 also receives location information (510), which may be a geoposition received from probe controller 110 or a zip code received on user input device 330. Next, processor 310 determines a regional UVI applicable to the sensing period t and an extended period T using the location information and time information (515). For example, if the sensing period t was between 10 a.m. and 2 p.m. on Mar. 18, 2008, UVI queries may request the daily regional UVI for the location on Mar. 18, 2008 as well as an average regional UVI for the location during a recent month or year. Processor 310 formulates one or more UVI queries having the location information and time information that are transmitted to server 140 via network interface 340. In response to the UVI queries, server 140 returns one or more query responses having regional UVI applicable to the sensing period UVIₜ and extended period UVI_{T}. Next, processor 310 estimates regional PAR applicable to the sensing period t and extended period T using the regional UVI (520). For example, processor 310 may apply the mathematical relationship between UVI and PAR shown in FIG. 4 to estimate a regional PAR applicable to the sensing period PARₜ and extended period PAR_{T} using the regional UVI applicable to the sensing period UVIₜ and extended period UVI_{T}, respectively. The mathematical relationship used to estimate regional PAR may be a mathematical equation or may reside in a lookup table that is stored in memory 360 and consulted by processor 310, for example. Next, processor 310 calculates a sensor-based PAR normalization factor K by dividing the regional PAR applicable to the extended period by the regional PAR applicable to the sensing period PAR_{T}/PARₜ (525). Finally, the non-normalized, sensor-based PAR data PAR_{U} is multiplied by the normalization factor K to produce normalized, sensor-based PAR data PAR_{S} (530). Processor 310 then compares the normalized, sensor-based PAR data PAR_{S} along with other environmental parameters, for example, sensor-based temperature, humidity and soil data, with plant species profiles from a regional plant database to identify plant species suitable for installation at the proposed plant site or an adverse environmental condition affecting an installed plant, and outputs the plant evaluation information on user output device 320.

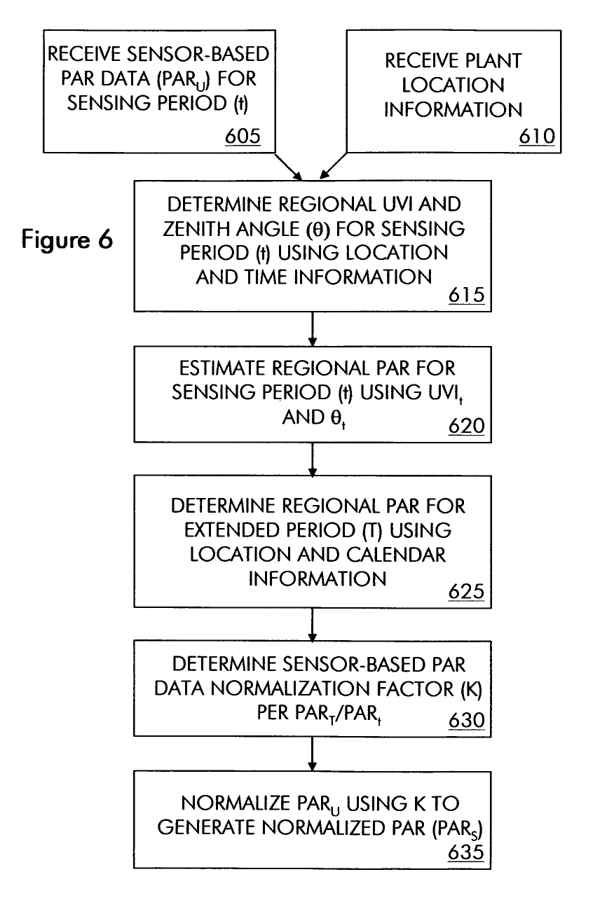

FIG. 6 shows a method for using UVI-based PAR data in a plant evaluation application in other embodiments of the invention. In these embodiments, zenith angle data are used in conjunction with UVI data to estimate regional PAR applicable to the sensing period PARₜ, and calendar and location information are used to directly determine regional PAR applicable to the extended period PAR_{T}. Turning to FIG. 6, processor 310 receives non-normalized, sensor-based PAR data PAR_{U} calculated by probe controller 110 based on light readings taken by light sensor 240 at the plant site over a sensing period t (605). The non-normalized, sensor-based PAR data PAR_{U} may be represented as average PAR during the sensing period t or may be a profile that describes PAR at various times during the sensing period t. Processor 310 also receives location information (610), which may be a geoposition received from probe controller 110 or a zip code received on user input device 330. Next, processor 310 determines a regional UVI and solar zenith angle (θ) applicable to the sensing period t using the location information and time information (615). For example, if the sensing period t was between 10 a.m. and 2 p.m. on Mar. 18, 2008, a UVI query may request the daily regional UVI for the location on Mar. 18, 2008 and zenith angle queries may request the hourly zenith angle for the location between 10 a.m. and 2 p.m. on Mar. 18, 2008. Processor 310 formulates a UVI query and zenith angle queries having location and time information and transmits the queries to server 140 via network interface 340. In response, server 140 returns query responses having a regional UVI UVIₜ and solar zenith angles θ, applicable to the sensing period t. Next, processor 310 estimates regional PAR applicable to the sensing period t using the regional UVI and zenith angles (620). For example, processor 310 may apply the mathematical relationship between UVI and PAR shown in FIG. 4 to estimate an uncorrected regional PAR applicable to the sensing period using the regional UVI applicable to the sensing period UVIₜ and then correct the regional PAR estimate using the zenith angles applicable to the sensing period to obtain an estimate of regional PAR applicable to the sensing period PARₜ. Next, processor 310 determines a regional PAR applicable to the extended period T directly using the location information and calendar information (625). Processor 310 formulates a direct PAR query having the location information and calendar information (e.g. the month within which the sensing period t occurred) and transmits the direct PAR query to server 140 via network interface 340. In response, server 140 returns a query response having a regional PAR PAR_{T} applicable to the extended period T. In this regard, server 140 in these embodiments hosts historical PAR data for various regions and calendar periods (e.g. months) and retrieves the historical PAR data in response to direct PAR queries. Next, processor 310 calculates a sensor-based PAR normalization factor K by dividing the regional PAR applicable to the extended period by the regional PAR applicable to the sensing period PAR_{T}/PARₜ (630). Finally, the non-normalized, sensor-based PAR data PAR_{U} is multiplied by the normalization factor K to produce normalized, sensor-based PAR data PAR_{S} (635). Processor 310 then compares the normalized, sensor-based PAR data PAR_{S} along with other environmental parameters, for example, sensor-based temperature, humidity and soil data, with plant species profiles from a regional plant database to identify plant species suitable for installation at the proposed plant site or an adverse environmental condition affecting an installed plant, and outputs the plant evaluation information on user output device 320.

It will be appreciated by those of ordinary skill in the art that the invention can be embodied in other specific forms without departing from the spirit or essential character hereof. For example, processing described herein as being performed on computer 120 may be performed on probe controller 110, or vice versa. Moreover, in some embodiments, UVI-based PAR data may be applied independently of sensor-based PAR data in a plant evaluation application, for example, to help identify plant species suitable for installation at a proposed plant site or an adverse environmental condition affecting an installed plant. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A computer, comprising:
a processor; and
a first communications interface communicatively coupled with the processor, wherein the computer receives via the first communications interface ultraviolet index (UVI) data and under control of the processor determines UVI-based photosynthetically active radiation (PAR) data as a function of the UVI data and applies the UVI-based PAR data in a plant evaluation application.

2. The computer of claim 1, further comprising a second communications interface communicatively coupled with the processor, wherein the computer receives via the second communications interface sensor-based PAR data and under control of the processor applies the sensor-based PAR data in conjunction with the UVI-based PAR data in the plant evaluation application.

3. The computer of claim 2, wherein under control of the processor the computer normalizes the sensor-based PAR data using the UVI-based PAR data.

4. The computer of claim 2, wherein the UVI-based PAR data comprises a first PAR estimate applicable to a sensing period and a second PAR estimate applicable to an extended period, and the computer under control of the processor normalizes the sensor-based PAR data using the first and second PAR estimates.

5. The computer of claim 4, wherein the first PAR estimate is determined using UVI data applicable to the sensing period.

6. The computer of claim 5, wherein the first PAR estimate is further determined using solar zenith angle data applicable to the sensing period.

7. The computer of claim 4, wherein the second PAR estimate is determined using UVI data applicable to the extended period.

8. The computer of claim 7, wherein the second PAR estimate is further determined using solar zenith angle data applicable to the extended period.

9. The computer of claim 4, wherein the second PAR estimate is determined using historical PAR data applicable to the extended period.

10. The computer of claim 1, wherein the computer receives location information and under control of the processor transmits via the first communications interface a UVI query comprising the location information in response to which the computer receives via the first communications interface the UVI data.

11. The computer of claim 10, wherein the computer receives the location information from a probe controller via a second communications interface.

12. The computer of claim 10, further comprising a user input device communicatively coupled with the processor, wherein the computer receives the location information via the user input device.

13. The computer of claim 1, wherein the plant evaluation application is a plant selection application.

14. The computer of claim 1, wherein the plant evaluation application is a plant health diagnostics application.

15. A plant evaluation method, comprising the steps of:
transmitting location information;
receiving UVI data in response to the location information;
determining UVI-based PAR data based at least in part on the UVI data; and
applying the UVI-based PAR data in a plant evaluation application.

16. The method of claim 15, further comprising the steps of:
receiving sensor-based PAR data; and
applying the sensor-based PAR data in conjunction with the UVI-based PAR data in the plant evaluation application.

17. The method of claim 16, wherein the applying step comprises normalizing the sensor-based PAR data using the UVI-bosed PAR data.

18. The method of claim 16, wherein the UVI-based PAR data comprises a first PAR estimate applicable to a sensing period and a second PAR estimate applicable to an extended period, and the applying step comprises normalizing the sensor-based PAR data using the first and second PAR estimates.

19. The method of claim 15, wherein the plant evaluation application is a plant selection application.

20. The method of claim 15, wherein the plant evaluation application is a plant health diagnostics application.
